(19) United States
(12) Patent Application Publication
(10) Pub. No.: US 2013/0342062 A1
(43) Pub. Date: Dec. 26, 2013

(54) MOTOR FOR ROTATIONALLY SUPPORTING A HARD DISK

(71) Applicant: Nidec Corporation, Kyoto (JP)

(72) Inventors: Yoichi SEKII, Kyoto (JP); Hironori ITSUSAKI, Kyoto (JP); Takeshi ICHINOSE, Kyoto (JP)

(21) Appl. No.: 13/922,343

(22) Filed: Jun. 20, 2013

Related U.S. Application Data
(60) Provisional application No. 61/662,943, filed on Jun. 22, 2012.

(51) Int. Cl. H02K 5/16; H02K 15/00

(52) U.S. Cl. CPC H02K 5/16; H02K 15/00
USPC 310/90; 29/598

(57) ABSTRACT

The present invention reduces contamination on a hard disk by adopting a new structural design for a motor. The motor of the present invention includes an adsorption plate portion in a magnetic space of the motor at a radially inward location relative to a disk placing portion on which hard disks are installed. The magnetic space of the motor is defined by a ceiling portion of a rotor hub and the adsorption plate portion. A liquid surface of lubricant of the fluid dynamic bearing mechanism is arranged radially inwardly relative to the adsorption plate portion, and a gap to which the liquid surface is exposed is connected to the magnetic space. The adsorption plate portion is preferably made of stainless steel. At least a portion of the surface of the adsorption plate portion is not covered with paint or other material so as to be utilized as an adsorption area.

### BACKGROUND OF THE INVENTION

1. Field of the Invention

The present invention relates to a motor for supporting one or more hard disk(s) on which digitized information is recorded. More specifically, the present invention is related to a motor used in an application where the disk(s) are required to be kept extremely clean.

2. Description of the Related Art

Generally, oils having lower viscosities are preferable for bearings, especially fluid dynamic bearing for spindle motors of hard disk drives. Viscosity of oil is a major cause of frictional loss of a fluid dynamic bearing. Oil with lower viscosity, however, has higher evaporation rate, which means that such oil evaporates relatively easily. Therefore, manufacturers of conventional motors for hard disk drives permit certain rate of oil evaporation, and manufacturers of hard disk drives have no choice but to tolerate such evaporation, knowing that the evaporated oil could become a contaminant on a disk. Such toleration is increasingly costly as information density on disks and disk's vulnerability to contaminants increase.

### SUMMARY OF THE INVENTION

Preferred embodiments of the present invention reduce contamination by adopting a new structural design for a motor. For example, preferred embodiments of the present invention provide a motor for a hard disk drive including an adsorption plate portion in a magnetic space of the motor at a radially inward location relative to a disk placing portion on which hard disks are installed. The magnetic space of the motor is defined by a ceiling portion of a rotor hub and the adsorption plate portion. A liquid surface of lubricant of the fluid dynamic bearing mechanism is arranged radially inwardly relative to the adsorption plate portion, and a gap to which the liquid surface is exposed is connected to the magnetic space. At least a portion of the surface of the adsorption plate portion is not covered with paint or other material so as to be utilized as an adsorption area.

The adsorption plate portion is preferably made of stainless steel. The metallic surface of the stainless steel is exposed to the magnetic space at the adsorption area. The metallic material is not limited to stainless steel, but a contact angle of the lubricant oil relative to the surface of the metallic material should be smaller than that relative to the surface of the base main body. The base main body is made of aluminum and covered with paint material.

More vaporized lubricant adheres to a surface on which the lubricant in liquid state exhibits smaller contact angle. The amount of vaporized lubricant which escapes from a magnetic space into a disk space where a hard disk is accommodated is reduced because a portion of the vaporized lubricant adheres to the surface of the adsorption area.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 illustrates a perspective view of an exemplary hard disk drive according to a preferred embodiment of the present invention.

FIG. 2 illustrates a perspective view of the drive base according to a preferred embodiment of the present invention.

FIG. 3A and FIG. 3B illustrate a perspective view and a plan view of the motor base according to a preferred embodiment of the present invention.

FIG. 4 illustrates a vertical section of the drive around a motor according to a preferred embodiment of the present invention.

FIG. 5 illustrates the arrangement of a magnetic space and a connecting gap according to a preferred embodiment of the present invention.

FIG. 6 illustrates a vertical section of a portion of a motor according to a preferred embodiment of the present invention.

FIG. 7 illustrates an enlarged vertical section of a portion of a motor according to a preferred embodiment of the present invention.

FIG. 8 illustrates an enlarged vertical section of another portion of a motor according to a preferred embodiment of the present invention.

FIG. 9 illustrates a drive base according to a preferred embodiment of the present invention.

FIG. 10 illustrates a vertical section of a motor according to a preferred embodiment of the present invention.

FIGS. 11A and 11B show non-limiting examples of preferable processes of assembling a motor of according to preferred embodiments of the present invention.

FIG. 12 shows a non-limiting example of a preferable process of assembling a motor according to a preferred embodiment of the present invention.

### DETAILED DESCRIPTION OF THE PREFERRED EMBODIMENTS

### First Preferred Embodiment

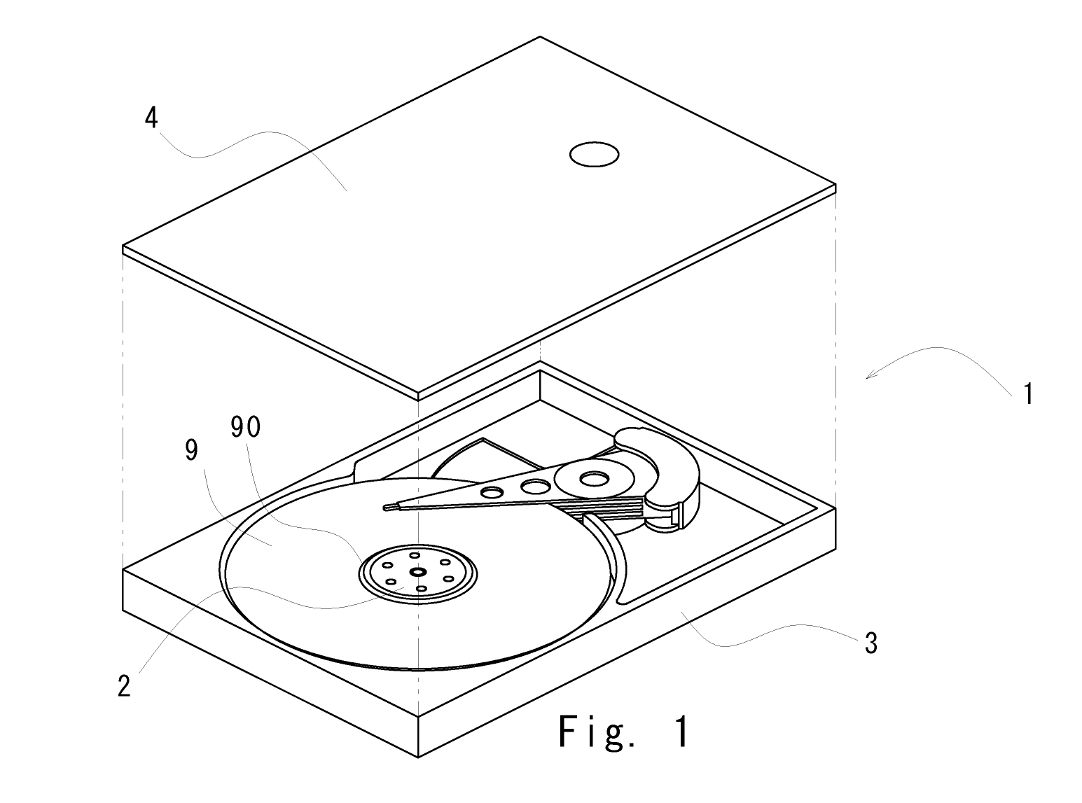

Preferred embodiments of the present invention will now be described with reference to FIGS. 1 to 12. It should be noted that in the explanation of the preferred embodiments of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel or substantially parallel to a rotation axis, and a radial direction indicates a direction perpendicular or substantially perpendicular to the rotation axis.

FIG. 1 illustrates a perspective view of an exemplary hard disk drive 1 in which a motor 2 is installed in accordance with a preferred embodiment of the present invention. The drive 1 includes a drive base 3 and a cover 4 that is arranged to cover and to close the upper portion of the drive base 3 hermetically. The closed space defined by the drive base 3 and the cover 4 is required to be kept clean for years to avoid contaminating a disk.

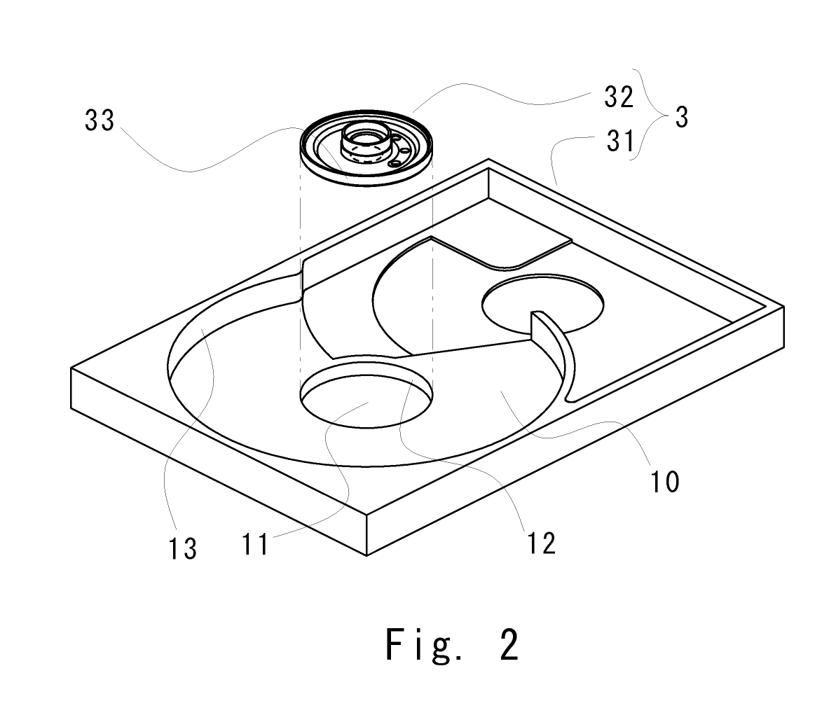

FIG. 2 presents a perspective view of a drive base 3 including a base main body 31 and a motor base 32. The other parts of the hard disk drive and the motor 2 except the motor base 32 are not shown in FIG. 2. The base main body 31 preferably includes a through hole 11. The through hole 11 is an accommodating portion in this preferred embodiment, which accommodates the motor base 32, and the inner circumferential surface 12 of the through 11 contacts the outer circumferential surface 33 of the motor base 32 after it is fixed to the base main body 31. A hole having a bottom at the lower end may alternatively be provided as an accommodating portion in place of the through hole. A flat C-shaped area 10 is preferably arranged to surround the accommodating portion 11 and extends radially outwardly from the accommodating portion. A C-shaped wall 13 preferably stands at the radially outer end of the C-shaped flat area 10 and surrounds the C-shaped flat area 10. The C-shaped wall 13, the C-shaped area 10, and the cover 4 (shown in FIG. 1) define a space where the motor 2 and the hard disk 9 are arranged. At least a portion of the C-shaped flat area 10 of the base main body 31 is preferably made of aluminum alloy including, for example, aluminum with smaller amount of Si and other additives. The motor base 32 is preferably a portion of the drive base 3. It provides a base portion of the motor of the present preferred embodiment of the present invention including a bearing mechanism.

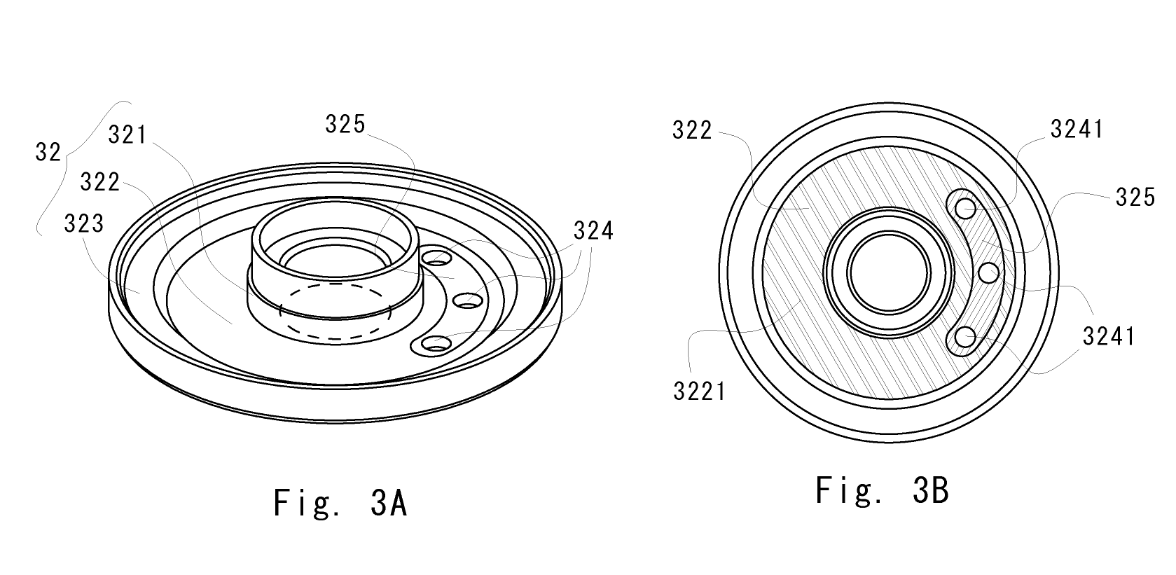

FIG. 3A and FIG. 3B show a perspective view and a plan view of the motor base 32 respectively. The motor base 32 preferably includes a stator supporting portion 321 having a cylindrical shape. Most portion of a bearing mechanism, which is explained in further detail below, is located inside of the stator supporting portion 321. An adsorption plate portion 322 extends radially outwardly from lower portion of the stator supporting portion 321. The adsorption plate portion 322 preferably has a circular flat shape and three through holes 324, for example. The edges of openings of the through holes 324 are preferably covered by an insulating bush 325 having through holes 3241 overlapping the through holes 324 on the motor base 32. The insulating bush is preferably made of, for example, a resin material having an arc shape. A potion of the upper surface of the adsorption plate portion 321 is preferably shaped to include a concavity into which the insulating bush 325 is fitted. The motor base 32 also preferably includes a raised portion 323 at a radially outer location relative to the adsorption plate portion 322. The raised portion 323 preferably includes a circular upper surface which is located at an axially higher position relative to the upper surface of the adsorption plate portion 322. The through holes are preferably sealed with sealant in an airtight manner after conducting wires from coils (not shown) are inserted into the holes to reach a lower side of the motor base 32.

The motor base 32 including the adsorption plate portion 322 is preferably a single monolithic piece made of a ferritic stainless steel. The stator supporting portion 321, the adsorption plate portion 322, and the raised portion 323 may be lathed or formed separately from different materials, but at least a portion of the upper surface of the adsorption plate portion 322 should be made of or covered with a ferritic stainless steel. An area of the upper surface of the adsorption plate portion 322 which is made of or covered with a ferritic stainless steel is preferably an adsorption area 3221. The motor of preferred embodiments of the present invention uses liquid lubricant including an ester oil for its bearing mechanism. The contact angle of the liquid lubricant to the adsorption area 3221 is preferably about 10 degrees at room temperature, while a contact angle of the liquid lubricant to the surface of the base main body 31, which is coated with paint material, is preferably more than about 20 degrees. The smaller contact angle means that the liquid has larger affinity to that surface. Therefore, the smaller contact angle on the adsorption area 3221 ensures that some portions of molecules of evaporating lubricant are adsorbed on the surface of the adsorption area 3221, and the amount of lubricant vapor that diffuses into the inner space of the hard disk drive 1 is reduced.

The surface of the adsorption area 3221 preferably should be cleaned to make a contact angle of liquid lubricant sufficiently small before it is installed to the base main body 31. The motor base 32 of the present preferred embodiment is preferably washed by ultrasonic cleaning with organic solvents including hydrocarbons having a boiling temperature higher than a room temperature. The liquid hydrocarbon may be selected from, for example, paraffin hydrocarbons and olefin hydrocarbons, ether, or mixture of these. Ultrapure water is also used for the ultrasonic cleaning after ultrasonic cleaning with organic solvent. The power of ultrasound applied to washing liquid, which is liquid hydrocarbon or ultrapure water, is preferably larger than about 10 Watts per liter but not exceeding about 90 Watts per liter. The frequency of the ultrasound is preferably higher than about 20 kHz but not exceeding about 150 kHz. These conditions of the power and the frequency and the combination of multi-step cleaning with different solvents can not only clean the motor base 32 but can also make the contact angle of liquid lubricant sufficiently small. A contact angle usually depends on a kind of liquid lubricant. The liquid lubricant of this preferred embodiment preferably includes a ester and exhibits small contact angle of less than about 10 degrees if its drop is put on the adsorption area 3221 of the motor base 32.

The metallic material of which the surface of the adsorption area is made is not limited to ferritic stainless steel. For example, austenitic stainless steel is one of the possible alternatives. Both surfaces of ferritic stainless steel and austenitic stainless steel are covered with an atomically thin layer including chromium(III) oxide. The small contact angles on a surface of stainless steels originate from the property of chromium(III) oxide. A heating treatment after washing to dry a motor base is effective to increase the affinity of an ester oil to the surface thereof, especially if it is heated equal to or higher than about 60 degrees Celsius. Nickel or nickel based alloys are also usable as other alternatives in accordance with preferred embodiments of the present invention. The surfaces of these metals are covered with atomically thin layer including nickel oxide like stainless steels, while the surface of aluminum is covered with aluminum oxide on which the contact angle of liquid lubricant is larger.

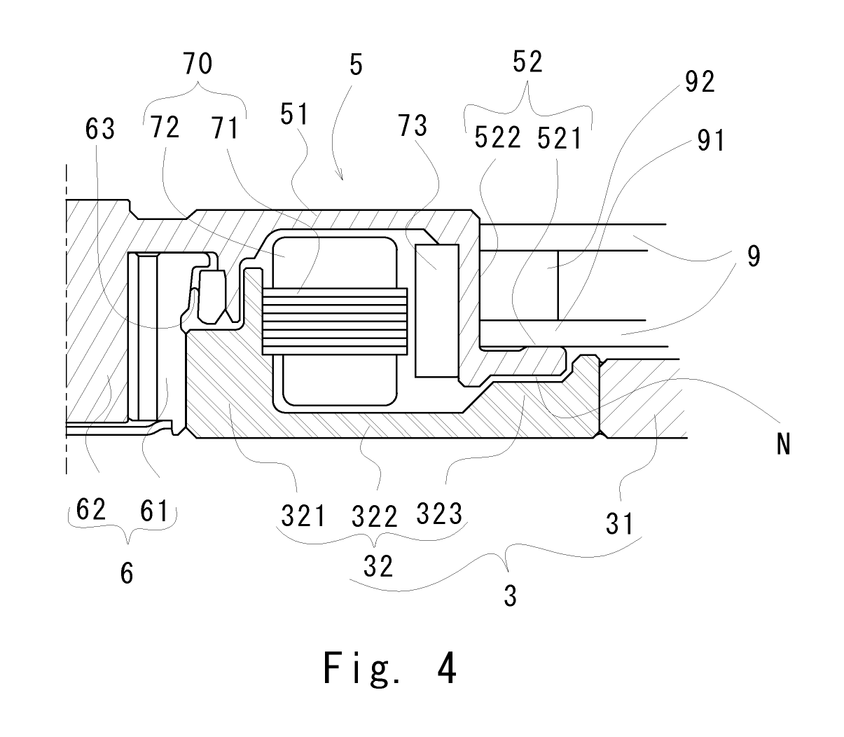

FIG. 4 presents a vertical section of the drive 1 around the motor 2 of a preferred embodiment of the present invention. The motor 2 is preferably installed on the motor base 32 including a bearing mechanism 6. The motor base 32 preferably includes a stator supporting portion 321, an adsorption plate portion 322, and a raised portion 323. The stator supporting portion 321 preferably has a cylindrical shape extending along the axial direction of the bearing mechanism 6 which is a vertical direction in the FIG. 4. The stator core 71 is preferably fixed to the stator supporting portion 321 in contact with the outer circumferential surface thereof. Coils 72, each made of wound electrically conducting wire, are preferably attached to the stator core 71. There is a space inside the stator supporting portion 321 in which the bearing mechanism 6 is installed. The bearing mechanism preferably includes a shaft 62 being rotatably inserted into a cylindrical bore of the sleeve 61. The outer circumferential surface of the sleeve 61 preferably contacts the inner circumferential surface of the stator supporting portion 321 and is fixed hermetically thereto so that the space below the motor base 32 is separated from the space above the motor base 32.

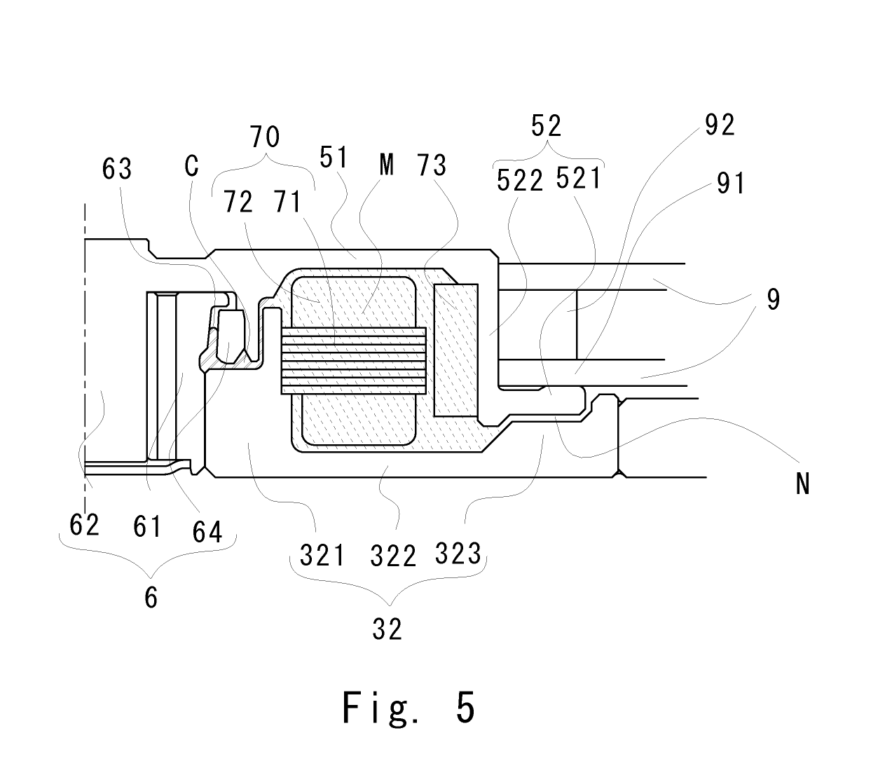

A rotor hub 5 preferably includes a ceiling portion 51 and a disk placing portion 52. The disk placing portion 52 includes a ring portion 521 including a circular surface extending radially and a cylindrical portion 522 having a cylindrical shape extending axially from the inner end of the ring portion 521. The ceiling portion 51 extends radially inwardly from the upper end of the cylindrical portion 522. The radially inner end area of the ceiling portion 522 connects with the upper end portion of the shaft 62. The rotor hub 5 and the shaft 62 is preferably a single monolithic piece made, for example, by lathing a disk shaped plate made of ferritic stainless steel. All of the surfaces of the rotor hub 5 are preferably lathed surfaces and washed by ultrasonic cleaning before the rotor hub 5 is assembled to the bearing mechanism 6. The shaft 62 and the rotor hub 5 may alternatively be made separately, and then be joined to each other, if so desired. A conventional method to join a shaft to a rotor hub is that preparing a rotor hub having a through hole at the center thereof, press-fitting a shaft into the through hole. The method is also applicable to various preferred embodiments of the present invention, but the through hole of the rotor hub should be hermetically closed by the shaft. The feature ensures that the magnetic space M in FIG. 5, which is explained later, is separated from the inner space of the hard disk drive 1.

The bearing mechanism 6 shown in FIG. 4 is a rotational-shaft type of bearing in which a sleeve 61 is fixed to the cylindrical inner surface of the stator supporting portion 321 and a shaft 62 is rotationally supported by the sleeve 61. A rotor hub 5 is joined to an upper end portion of the shaft 62. Alternatively, another type of bearing mechanism in which a shaft is fixed to a motor base such that the shaft rotationally supports a sleeve can be adapted to various preferred embodiments of the present invention. Various preferred embodiments of the present invention are designed to be utilized with a fluid dynamic bearing as the bearing mechanism in which lubricant liquid whose viscosity is smaller than that for conventional bearings which use steel balls. Ester-based oils or ether-based oils, for example, are preferably chosen as a lubricant liquid for most fluid dynamic bearings to meet the demand for viscosity as well as relatively low evaporation rate. A fluid dynamic bearing includes at least one liquid surface, i.e. lubricant surface or oil-air interface, which is shown in FIG. 4 denoted by a number of 63. This oil-air interface is referred to as a “first liquid surface” herein to distinguish another liquid surface appearing in another type of bearing mechanism which is explained later. The shape of the first liquid surface on a vertical section in FIG. 4 is preferably a small arc shape. It extends to surround the shaft 62. The axial position of the first liquid surface is lower than that of the ceiling portion 51, and is exposed to a magnetic space M or a connecting gap C which are depicted in FIG. 5.

FIG. 5 illustrates the arrangement of a magnetic space M and a connecting gap C in accordance with a preferred embodiment of the present invention. The magnetic space M preferably has a tubular shape defined by the inner surface of a cylindrical portion 522, the outer surface of a supporting portion 321, the lower surface of a ceiling portion 51, and the upper surface of an adsorption plate portion 322. A stator 70 and a rotor magnet 73 are preferably housed in the magnetic space M. The radially inner end of the magnetic space M joins to the outer end area of the connecting gap C. The connecting gap C is a narrow space defined by the upper portion of the supporting portion 321 and the lower end portion of the inner portion of the ceiling portion 51 to which a stopper 64 of the bearing mechanism 6 is fixed.

The motor base 32 preferably includes a supporting portion 321, an adsorption plate portion 322, and a raised portion 323. The supporting portion 321 has a cylindrical or approximately cylindrical shape extending in the axial direction of the bearing mechanism 6. A cylindrical peripheral surface of a bearing mechanism 6 preferably contacts, and is fixed to, the cylindrical inner surface of the supporting portion 321. The adsorption plate portion 322 extends radially from the lower end portion of the bearing support portion 321 and preferably surrounds the bearing support portion 321. The upper surface of the adsorption plate portion 322 is preferably not coated such that a metallic surface of stainless is exposed to the magnetic space M.

The rotor hub 5 preferably includes a ceiling portion 51 and a disk placing portion 52. The disk placing portion 52 preferably further includes a ring portion 521 and a cylindrical portion 522. The ring portion 52 contacts and supports an inner edge portion 91 of a center through hole of the hard disk 9. The ceiling portion 51 and the disk placing portion 52, including the ring portion 521 and the cylindrical portion 522, are portions of a single monolithic piece made of stainless steel. The rotor hub shown in FIG. 2 is designed to support two hard disks 9 which are arranged to be spaced apart in axial direction intervened by a spacer ring 92. Preferred embodiments of the present invention can also be adopted for a motor which includes only one hard disk. A cylindrical portion of a rotor hub for such a motor is shorter and includes only a circular step. Nonetheless, it is one of variants of the preferred embodiments of the present invention. The motor base 32 in FIG. 5 or FIG. 4 preferably includes a raised portion 323 which, together with a bottom surface of the disk placing portion 52, defines a narrow passage N that connects the magnetic space M and an outer hub space.

The liquid lubricant which lubricates the bearing mechanism 6 preferably includes, for example, an ester oil and additives. The ester based lubricant exhibits excellent performance as a lubricant. It, however, evaporates slowly but constantly. The evaporating lubricant diffuses from lubricant surface 63 to the connecting gap C and further flows into the magnetic space M. The bottom of the magnetic space M is defined by the upper surface of the adsorption plate portion 322 on which the adsorption area 3221 is arranged. Due to its affinity to the lubricant, the adsorption area 3221 adsorbs at least a portion of the evaporating lubricant, and, therefore, reduces the amount of the evaporating lubricant which moves out into a disk space outside the magnetic space M. One may select ferritic stainless steel as the material from which the rotor hub 5 is made. If the rotor hub made of ferritic stainless steel is also washed in a procedure like that for the adsorption plate portion 322, i.e., the combination of a first ultrasonic cleaning with liquid organic solvent and a second ultrasonic cleaning with ultrapure water, the lower surface of the ceiling portion can also adsorb the evaporating lubricant. It contributes to reduce the amount of evaporating lubricant that escapes into the disk space. The contact angle of the liquid lubricant to the lower surface of the ceiling portion 51 in this preferred embodiment is preferably about 10 degrees, while the contact angle to the base main body 31 coated with paint material is preferably more than about 20 degrees. Austenitic stainless steel, for example, is also applicable as a material of the motor base 32.

### Second Preferred Embodiment

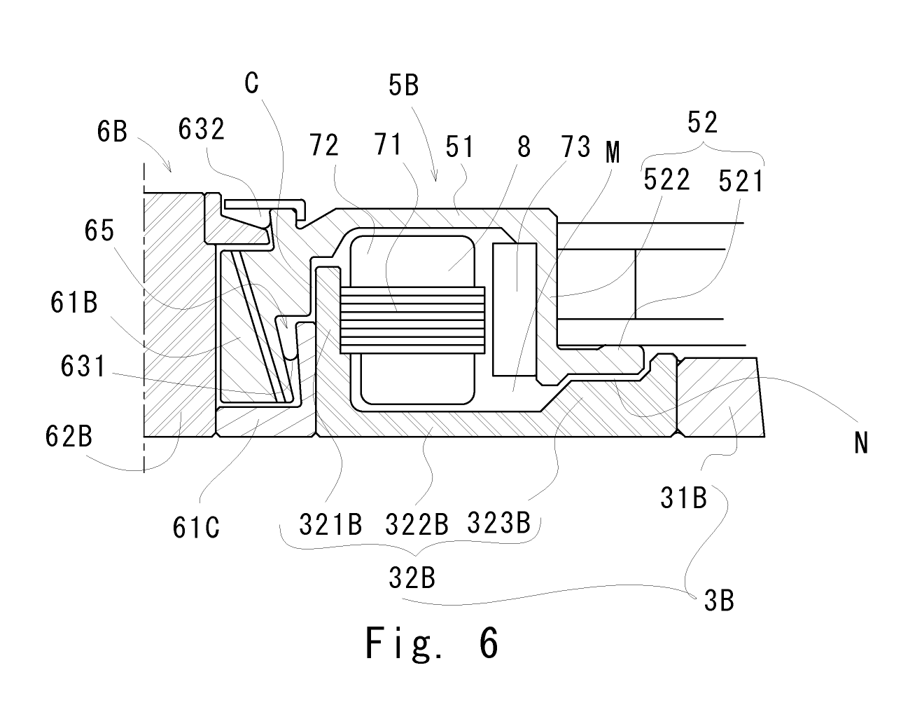

FIGS. 6 through 8 present vertical sections of another structure of a motor according to a second preferred embodiment of the present invention. The principal difference between the second preferred embodiment and the first preferred embodiment exists in the arrangement of a sleeve and a shaft. A shaft 62B of the motor of the second preferred embodiment is not rotational relative to a drive base 3B, while a sleeve 61B is rotationally supported by the shaft 62B and a bearing base 61C. The bearing base 61C preferably has a cup shape and the shaft 62B is fixed to a center through hole of the bearing base 61C. The outer circumferential surface of the bearing base 61C is preferably fixed to the inner circumferential surface of a supporting portion 321B of a motor base 32B. The other portions of the motor are preferably the same as the first preferred embodiment. The shape of the magnetic space, the effect of the adsorption plate portion 322B, and the position of a narrow passage N are also preferably the same to those of the first preferred embodiment.

The configuration of the second preferred embodiment is beneficial if a shaft is needed to be fixed at both ends. The top of the shaft 62B is preferably higher or slightly higher than any other portion of the motor. This feature makes it relatively easy to affix the top end of the shaft 62B to a cover 4. A shaft tied to a stationary portion at both ends is more rigid if the other configurations are same.

The bearing mechanism 6B in this configuration preferably includes two liquid surfaces, a first liquid surface 631 and a second liquid surface 632. The first liquid surface 631 is exposed to a connecting gap C which extends to a magnetic space M. While the axial position of the first liquid surface 631 is clearly lower than that of the ceiling portion 51, the axial position of the second liquid surface 632 is not. The axial position of the second liquid surface 632 is close or same to that of the ceiling portion.

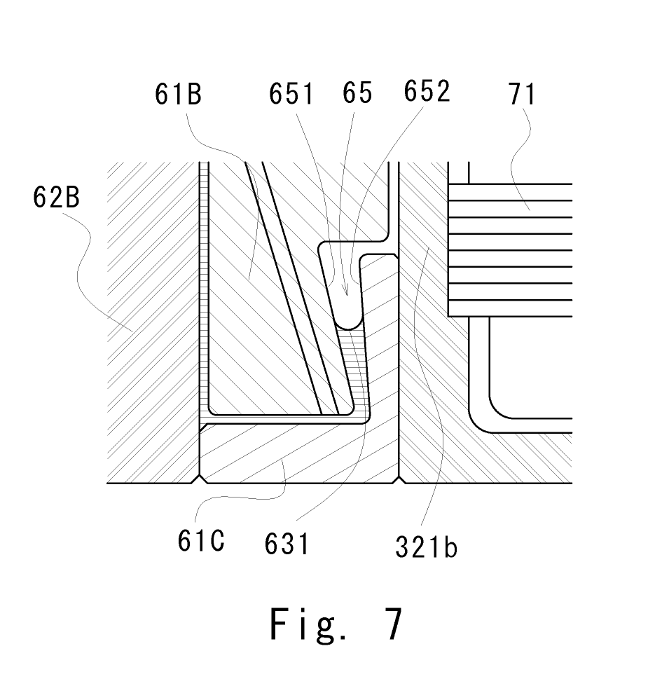

FIG. 7 shows an enlarged view around the first liquid surface 631 of FIG. 6. The first liquid surface is preferably located in a first tapering space 65 defined by a first pair of adjacent surfaces 651 and 652. Both surfaces slant in a way in which the surfaces extend away from the shaft 62B when they extend downwards. The degrees of slanting are preferably different. The angle to the axial direction of the surface 651, which is located radially inward relative to the other surface 652, is larger than that of the other surface 652. This configuration provides the tapering space 65 which tapers to a tip thereof. The surface 651 is a portion of the outer circumferential surface of the sleeve 61B. The surface 652 is a portion of the inner circumferential surface of the bearing base 61C.

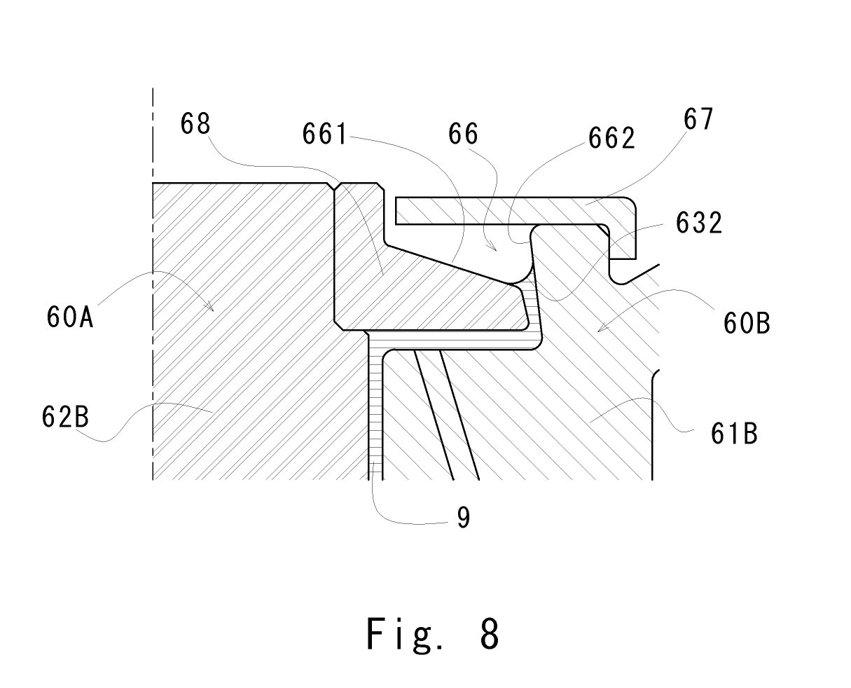

FIG. 8 is an enlarged view around the second liquid surface 632 of FIG. 6. There is a bearing stationary portion 60A which preferably includes a shaft 62B and a stopper 68. A bearing rotational portion 61B preferably includes a sleeve 61B and a cap 67 attached to the top of the sleeve 61B.

The second liquid surface is preferably located in a second tapering space 66 defined by a second pair of adjacent surfaces 661 and 662. Both surfaces slant in a way in which the surfaces extend away from the shaft 62B when they extend downwards. The degrees of slants are preferably different. The angle to the axial direction of the surface 661, which is located radially inward from the other surface 662, is larger than that of the other surface 662. This configuration provides the tapering space 66 which tapers towards a tip thereof. The surface 661 is a portion of the outer circumferential surface of the bearing stationary portion 60A. The surface 662 is a portion of the inner circumferential surface of the bearing rotational portion 60B. An angle defined by the second pair of adjacent surfaces 661 and 662 is larger than that of the first pair of adjacent surfaces 651 and 652 in FIG. 7. This arrangement makes the radial width of the second liquid surface 632 smaller than that of the first liquid surface 631. The second tapering space 66 is preferably located radially inward relative to the first tapering space 65. With these arrangements, the area of second liquid surface 632 is preferably smaller than that of the first liquid surface 631.

Unlike the first liquid surface 631, the second liquid surface 632 is preferably not accompanied by a magnetic space and an adsorption area which intervenes between the second liquid surface 632 and the disk space. Reducing the area of the second liquid surface is effective to reduce contamination originated from the second liquid surface 632.

### Third Preferred Embodiment

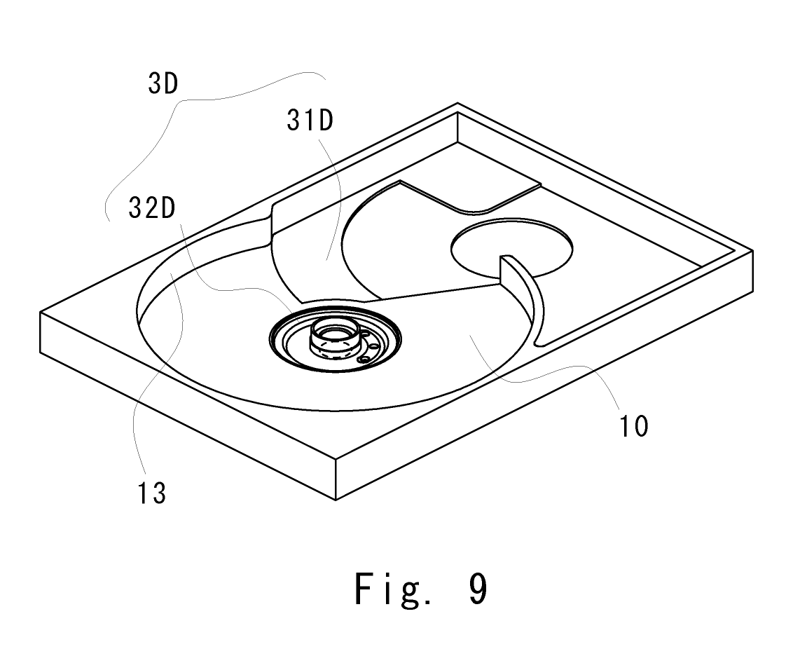

FIG. 9 illustrates a drive base 3D of the third preferred embodiment of the present invention. A base main body portion 31D and a motor base portion 32D are portions of a single monolithic member made of stainless steel. A C-shaped flat area 10 surrounds the motor base portion 32D. A C-shaped wall 13 stands at the radially outer end of the C-shaped flat area 10 surrounding the C-shaped flat area 10 and the motor base portion 32D. The C-shaped flat area 10 is a portion of the drive base 3D. A C-shaped wall 13 preferably stands at the radially outer end of the C-shaped flat area 10 surrounding the C-shaped flat area 10. The C-shaped wall 13 is also preferably a portion of the drive base 3D, but may be prepared separately from the drive base as another part if so desired.

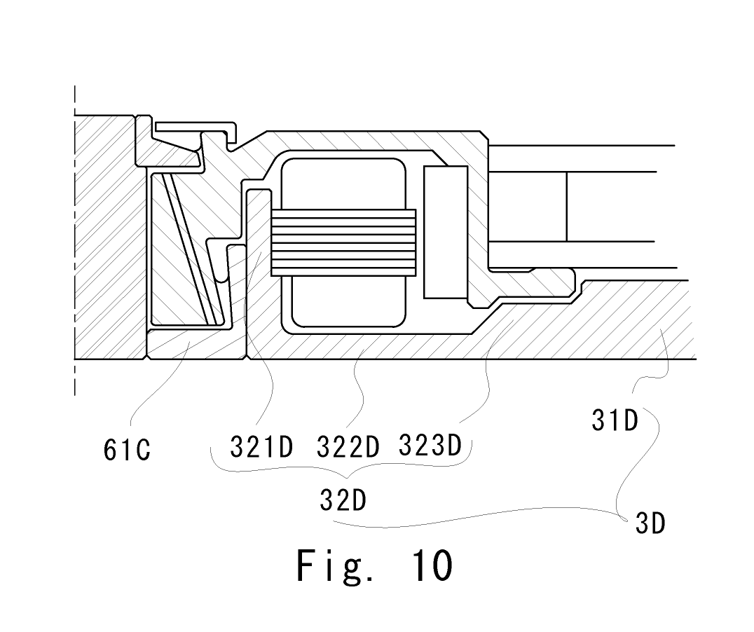

FIG. 10 is a vertical section of the motor of the present preferred embodiment. The motor base portion 32D preferably includes a supporting portion 321D, an adsorption plate portion 322D, and a raised portion 323D. The shapes and designs of these portions are the same to those of the second preferred embodiment except the feature that these portions are portions of the drive base 3D.

Adopting a specific method or procedure of assembling parts is beneficial to obtain a motor of the preferred embodiments of the present invention. Although an adsorption plate portion is washed and cleaned at a preparation process, a specific method helps keep or enhance the cleanness during the assembly process.

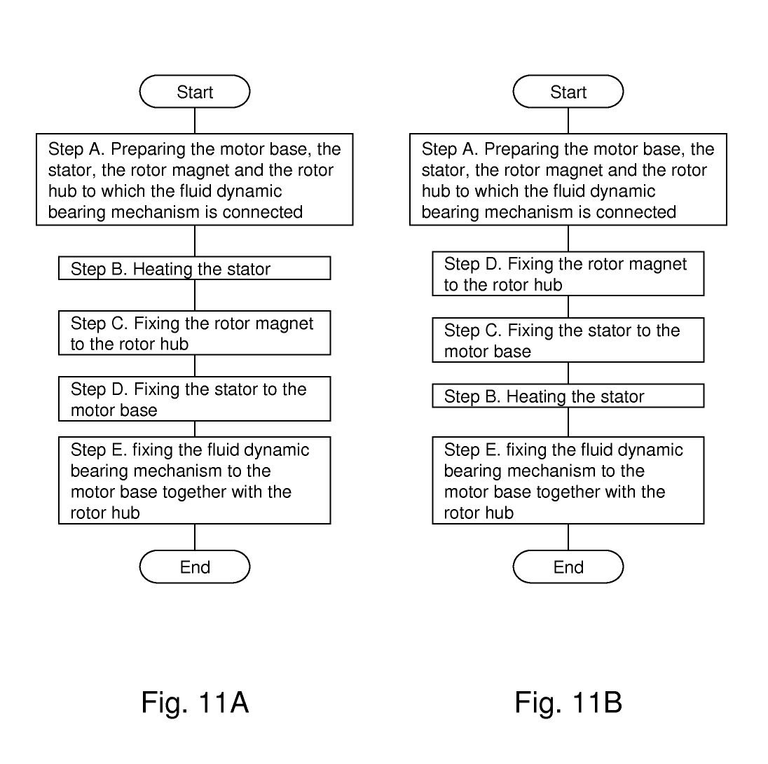

FIG. 11A shows an example of a preferable process of assembling a motor of various preferred embodiments of the present invention. At step A, a motor base, a stator, a rotor magnet and a rotor hub are prepared. The motor base should preferably be washed and cleaned by the combination of a first ultrasonic cleaning with organic solvent and a second ultrasonic cleaning with ultrapure water. A shaft of a fluid dynamic bearing mechanism should preferably be connected to the hub by the end of this step A.

At step B, the stator is preferably heated to about 90 degrees Celsius and the temperature is preferably kept for about 60 minutes. The stator of various preferred embodiments of the present invention preferably includes a stator core and plurality of coils each defined by winding a conducting wire and attached to the stator core. These windings provide larger surface area to the stator, and the surface is cleaned by heating because heating drives out molecules already existing on the surface of the wires. The stator has an ability to adsorb evaporating lubricant molecules after the heating. This helps reduce contamination on a hard disk by evaporating lubricant.

At step C, the rotor magnet is fixed to the rotor hub.

At step D, the stator is fixed to the motor base preferably after it is cooled to the room temperature.

At step E, the fluid dynamic bearing mechanism is fixed to the motor base.

The step B is preferably conducted under an ambient pressure one fourth of that at sea level. Low pressure helps drive out molecules adsorbed on the surface of the stator. Such an effect can be attainable at a pressure higher than one fourth of that at sea level, but it is preferable that the pressure is selected to be equal to or lower than one third of that at sea level.

The heating temperature at the step B is not limited to about 90 degrees Celsius. The temperature equal to about 60 degrees or higher can be selected for the step B. The temperature of higher than about 150 degrees Celsius, however, could damage coatings of the wires and is not recommended. The time to keep the temperature also is not limited to about 60 minutes. However, at least five minutes is needed. One may keep the temperature more than six hours. But such a long duration deteriorates the efficiency of production. Therefore, it is recommended to choose the time to keep the temperature to be less than about six hours.

FIG. 11B shows another example of preferable process of assembling a motor of various preferred embodiments of the present invention. The order of conducting the steps is different while a procedure of each step is the same to that of FIG. 11A. A stator is heated after it fixed to a motor base in this example.

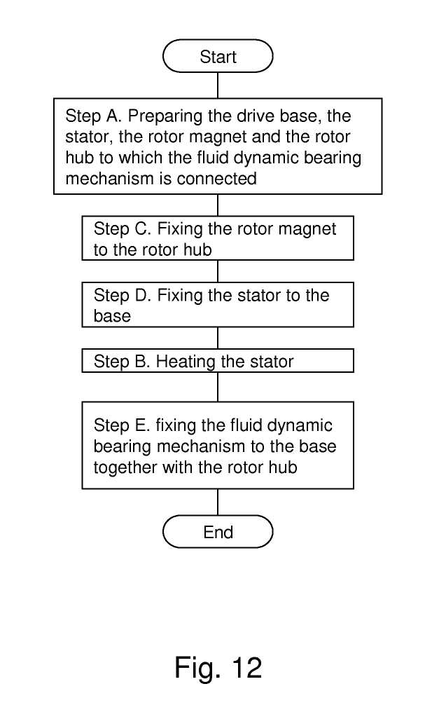

FIG. 12 shows another example of a preferable process of assembling a motor of the various preferred embodiments of the present invention. The process resembles to that shown in FIG. 11B, except the feature that the motor does not have a motor base as a separate portion. Therefore, a drive base, not a motor base, should preferably be washed and cleaned by a combination of a first ultrasonic cleaning with organic solvent and a second ultrasonic cleaning with ultrapure water.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor rotationally supporting a hard disk having a center hole, comprising:
a rotor hub including a disk placing portion contacted by an inner edge portion of the center hole and a ceiling portion extending radially inwardly from the disk placing portion;
a rotor magnet fixed to the rotor hub;
a stator including coils and arranged to magnetically interact with the rotor magnet;
a fluid dynamic bearing mechanism lubricated by liquid lubricant and connected to an inner end of the ceiling portion;
a motor base including a stator supporting portion that supports the stator and an adsorption plate portion extending radially outwardly from the stator supporting portion; and
a base main body having a flat shape extending radially outwardly and including an accommodating portion which accommodates the motor base and includes an inner circumferential surface contacting an outer circumferential surface of the motor base; wherein
the fluid dynamic bearing mechanism includes a bearing stationary portion and a bearing rotational portion;
the bearing rotational portion includes either one of a shaft or a sleeve;
the bearing stationary portion includes the other of the shaft or the sleeve;
the ceiling portion and the adsorption plate portion are arranged to overlap and be spaced apart in an axial direction so as to define a magnetic space in which the rotor magnet and the stator are housed;
the disk placing portion surrounds the magnetic space;
the fluid dynamic bearing mechanism includes a first liquid surface of the liquid lubricant that surrounds at least the shaft;
a connecting gap is arranged between the bearing rotational portion and the bearing stationary portion, is located radially inwardly relative to the magnetic space, and extends from the magnetic space to the first liquid surface;
the base main body is made of a first material, which is a metallic material;
the adsorption plate portion includes an adsorption area made of a second material which is a metallic material; and
a contact angle of the liquid lubricant relative on a surface of the adsorption area is smaller than a contact angle of the liquid lubricant relative on a surface of the base main body.

2. The motor of claim 1, wherein the adsorption area extends around a center axis of the bearing mechanism over about 180 degrees.

3. The motor of claim 1, wherein
the accommodating portion includes a through hole axially penetrating the base main body; and
the outer circumferential surface of the motor base is hermetically secured to the inner surface of the through hole.

4. The motor of claim 2, wherein
the accommodating portion is a through hole axially penetrating the base main body; and
the outer circumferential surface of the motor base is hermetically secured to the inner surface of the through hole portion.

5. The motor of claim 1, wherein the liquid lubricant includes an ester oil.

6. The motor of claim 4, wherein the liquid lubricant includes an ester oil.

7. The motor of claim 1, wherein
the adsorption plate portion and the rotor hub are made of the second material; and
the rotor hub is defined by a single monolithic member.

8. The motor of claim 6, wherein
the adsorption plate portion and the rotor hub are made of the second material; and
the rotor hub is defined by a single monolithic member.

9. The motor of claim 1, wherein
the fluid dynamic bearing mechanism includes a first tapering space defined by a first pair of adjacent surfaces, a distance between which is tapered toward a tip of the first tapering space;
the fluid dynamic bearing mechanism includes a second tapering space defined by a second pair of adjacent surfaces, a distance between which is tapered toward a tip of the second tapering space;
the fluid dynamic bearing mechanism includes a first liquid surface of the liquid lubricant located in the first tapering space, which surrounds the shaft;
the fluid dynamic bearing mechanism includes a second liquid surface located in the second tapering space when the bearing rotational portion is not rotating relative to the bearing stationary portion;
the second liquid surface is located at an upper position relative to the first liquid surface in the axial direction;
at least one of the first pair of surfaces and the second pair of surfaces is a relatively movable pair of surfaces including a stationary surface of the bearing stationary portion and a rotational surface of the bearing rotational portion.

10. The motor of claim 8, wherein
the fluid dynamic bearing mechanism includes a first tapering space defined by a first pair of adjacent surfaces, a distance between which is tapered toward a tip of the first tapering space;
the fluid dynamic bearing mechanism includes a second tapering space defined by a second pair of adjacent surfaces, a distance between which is tapered toward a tip of the second tapering space;
the fluid dynamic bearing mechanism includes a first liquid surface of the liquid lubricant located in the first tapering space, which surrounds the shaft;
the fluid dynamic bearing mechanism includes a second liquid surface located in the second tapering space when the bearing rotational portion is not rotating relative to the bearing stationary portion;
the second liquid surface is located at an upper position relative to the first liquid surface in the axial direction;
at least one of the first pair of surfaces and the second pair of surfaces is a relatively movable pair of surfaces including a stationary surface of the bearing stationary portion and a rotational surface of the bearing rotational portion.

11. A motor rotationally supporting a hard disk having a center hole, comprising:
a rotor hub including a disk placing portion contacted by an inner edge portion of the center hole and a ceiling portion extending radially inwardly from the disk placing portion;
a rotor magnet fixed to the rotor hub; and
a stator including coils and arranged to magnetically interact with the rotor magnet;
a bearing mechanism connected to an inner end of the ceiling portion;
a drive base including a motor base portion and a base main body portion; wherein
the motor base portion includes a stator supporting portion which supports the stator and an adsorption plate portion extending radially outwardly from the stator supporting portion;
the base main body portion having a flat shape which surrounds the motor base portion;
the drive base including the motor base portion and the base main body portion is defined by a single monolithic member made of a metallic material;
the fluid dynamic bearing mechanism includes a bearing stationary portion and a bearing rotational portion;
the bearing rotational portion includes either one of a shaft or a sleeve;
the bearing stationary portion includes the other of the shaft or the sleeve;
the ceiling portion and the adsorption plate portion are arranged to overlap and be spaced apart in an axial direction so as to define a magnetic space in which the rotor magnet and the stator are housed;
the disk placing portion surrounds the magnetic space;
the fluid dynamic bearing mechanism includes a first liquid surface of the liquid lubricant that surrounds at least the shaft;
a connecting gap is arranged between the bearing rotational portion and the bearing stationary portion, located radially inwardly to the magnetic space, and extends from the magnetic space to the first liquid surface; and
a contact angle of the liquid lubricant relative to a surface of the adsorption area is smaller than about 15 degrees at room temperature.

12. The motor of claim 11, wherein the liquid lubricant includes an ester oil.

13. The motor of claim 11, wherein
the base main body is made of a first material, which is a metallic material;
the adsorption plate portion includes an adsorption area made of a second material, which is a metallic material; and
the rotor hub is a single monolithic piece made of the second material.

14. A method of assembling the motor of claim 1 comprising steps of:
(A) preparing the motor base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the motor base; and
(E) fixing the fluid dynamic bearing mechanism to the motor base together with the rotor hub; wherein
the step (B) is carried out before the step (E) is carried out;
the step (C) is carried out before the step (E) is carried out; and
the stator is heated to a temperature equal to or higher than about 60 degrees Celsius for at least about five minutes in the step (B).

15. A method of assembling the motor of claim 8 comprising steps of:
(A) preparing the motor base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the motor base; and
(E) fixing the fluid dynamic bearing mechanism to the motor base together with the rotor hub; wherein
the step (B) is carried out before the step (E) is carried out;
the step (C) is carried out before the step (E) is carried out; and
the stator is heated to a temperature of equal to or higher than about 60 degrees Celsius for at least about five minutes in the step (B).

16. A method of assembling the motor of claim 10 comprising steps of:
(A) preparing the motor base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the motor base; and
(E) fixing the fluid dynamic bearing mechanism to the motor base together with the rotor hub; wherein
the step (B) is carried out before the step (E) is carried out;
the step (C) is carried out before the step (E) is carried out; and
the stator is heated to a temperature of equal to or higher than about 60 degrees Celsius for at least about five minutes in the step (B).

17. A method of assembling the motor of claim 11 comprising steps of:
(A) preparing the base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the base; and
(E) fixing the fluid dynamic bearing mechanism to the base together with the rotor hub; wherein
the step (B) is carried out before the step (E) is carried out;
the step (C) is carried out before the step (E) is carried out; and
the stator is heated to a temperature of equal to or higher than about 60 degrees Celsius for at least about five minutes in the step (B).

18. A method of assembling the motor of claim 12 comprising steps of:
(A) preparing the base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the base; and
(E) fixing the fluid dynamic bearing mechanism to the base together with the rotor hub; wherein
the step (B) is carried out before the step (E) is carried out;
the step (C) is carried out before the step (E) is carried out; and
the stator is heated to a temperature of equal to or higher than about 60 degrees Celsius for at least about five minutes in the step (B).

19. A method of assembling the motor of claim 13 comprising steps of:
(A) preparing the base, the stator, the rotor magnet and the rotor hub to which at least a portion of the fluid dynamic bearing mechanism is connected;
(B) heating the stator;
(C) fixing the rotor magnet to the rotor hub;
(D) fixing the stator to the base; and
(E) fixing the fluid dynamic bearing mechanism to the base together with the rotor hub; wherein
the step (B) is carried out before the step (E) is carried out;
the step (C) is carried out before the step (E) is carried out; and
the stator is heated to a temperature of equal to or higher than about 60 degrees Celsius for at least about five minutes in the step (B).

20. The method of claim 16, wherein at least a portion of the step (B) is carried out under an ambient pressure equal to or lower than one third of an ambient pressure at sea level.
